(19) United States
(12) Patent Application Publication
(10) Pub. No.: US 2013/0063026 A1
(43) Pub. Date: Mar. 14, 2013

(54) Towed Vehicle Light-Sensitive External Lighting Control Device

(71) Applicant: Keith Stickley, Frederick, MD (US)

(72) Inventor: Keith Stickley, Frederick, MD (US)

(21) Appl. No.: 13/609,560

(22) Filed: Sep. 11, 2012

Related U.S. Application Data
(60) Provisional application No. 61/533,378, filed on Sep. 12, 2011.

(51) Int. Cl. B60Q 1/26

(52) U.S. Cl. 315/77

(57) ABSTRACT

Disclosed is a towed vehicle electrical connector that operably routes onboard battery power within the vehicle to exterior lighting when disconnected from a towing vehicle and when ambient light conditions drop below a given threshold. The device comprises an electrical module connectable to a trailer lead vehicle electrical connector, wherein the module includes an electrical circuit to route onboard battery power into a relay and through the exterior lights and to ground. The relay is controlled by a light sensitive switch, which monitors ambient light and allows the battery to energize the trailer exterior lights. The device provides a trailer user with a twilight lighting system, which illuminates an area about the vehicle for increased security and low light visibility.

### CROSS REFERENCE TO RELATED APPLICATION

This application claims the benefit of U.S. Provisional Application No. 61/533,378 filed on Sep. 12, 2011, entitled “Camper Security.” The above identified patent application is herein incorporated by reference in its entirety to provide continuity of disclosure.

### BACKGROUND OF THE INVENTION

1. Field of the Invention

The present invention relates to towed trailers and recreational vehicles. More specifically, the present invention pertains to trailer exterior lighting and a means of controlling the exterior running lights of a trailer using a light sensor switch attachable to the lead vehicle power cord connector.

Camping overnight and resting in a towed recreational vehicle or trailer is a common activity. During summer months, families spend time outdoors in campers and trailers to enjoy the weather and nature. It is common for individuals to park their trailer in a campground, set up camp and stay overnight or for several days and nights. It is further common for campgrounds to be used as a resting place during long cross-country drives, as these areas are generally less expensive than hotels or other accommodations. A common problem in these areas is the security of the individual's campsite area, his vehicle security and the security of his belongings. This is particularly true in twilight hours, as these areas generally have very little man-made light sources, and therefore campers must rely on vehicle-powered lighting and the light provided by camp fires and moon light.

It is submitted that in these scenarios, a lit campsite is more secure and inviting than one that has no means of providing night time vision. Campfires dwindle without attention and the use of individual flashlights is not always convenient. It is also sometimes required for camp-goers to exit their vehicle to use the facilities, to check their camp site at night or begin the next day before the sun rises in the morning. For these reasons and these situations, the present invention is discloses a twilight trailer lighting system that is adapted for towable trailers and recreational vehicles, wherein the trailer running lights can be energized for illuminating an area proximate to the trailer, such as the local campground being utilized.

The present invention comprises a connector module that is adapted to secure to a seven-pin trailer power plug, which generally draws charging power directly from the towing vehicle battery. The module provides an internal circuit that connects the trailer battery to the trailer running lights through a light sensor switch. The switch meters the ambient light outside of the trailer, closing the switch and energizing the trailer lights when the light dims below a threshold level, and opening the switch to turn off the trailer lights when sufficient light is present that the trailer lights are no longer required. This provides a means to regulate the lighting environment around the trailer in twilight and reduce power drainage during daylight hours, all while the trailer is disconnected from the towing vehicle power. The campground and area adjacent to the trailer is therefore more secure and more readily visible at night for campground users and trailer owners.

2. Description of the Prior Art

Devices have been disclosed in the prior art that relate to trailers and vehicle lighting systems. These include devices that have been patented and published in patent application publications, and generally relate to control systems for operating vehicle and trailer lighting systems while in operation or while driving. The forgoing is a list of devices deemed most relevant to the present disclosure, which are herein described for the purposes of highlighting and differentiating the unique aspects of the present invention, and further highlighting the drawbacks existing in the prior art. These devices represent lighting systems that improve roadway visibility and control over external lighting; however no such device is disclosed having the ability to modulate a camper or trailer external lighting using a light sensor through a trailer power cord module.

Specifically, U.S. Pat. No. 5,719,552 to Thompson discloses an automatic trailer illuminating system that activates and deactivates an area illuminating light that shines onto an area proximate to the trailer based on conditions established by the light controller. The light provides an auxiliary light when backing up, and while loading or unloading cargo onto the trailer. The use of standard, plug-in auxiliary lighting is that it may be inadvertently left on and drain the battery, or the user may have to handle the light while engaging in other loading/unloading activities. The Thompson device provides an auxiliary light that is operable by the user and can automatically activate or deactivate based on its control settings, such as when backing up or when water is sensed for a boat trailer. The present invention provides a twilight camper or trailer lighting system that is operable in low light and automatically activated using a light sensor switch. It is not contemplated to be utilized as the Thompson device, such as for auxiliary lighting when such lighting is typically required by the user.

Another such device is U.S. Pat. No. 4,024,497 to Ruppel, which discloses a tractor trailer rig lighting system that connects additional lights to existing light wiring for increased exterior and peripheral vision about the trailer while engaging in tight maneuvers. The additional lighting is energized when the existing running lights are turned on, and further when the turn signal lights are energized. This provides increased visibility when a tractor trailer is taking a tight turn and when visibility of the rear of the trailer is difficult for the driver. The increased lighting provides the driver with knowledge of the trailer rear during turns such that it does not clip or run over curbs, sidewalks or high signs or lights on street corners. The Ruppel device provides tractor trailer operating lights for maneuvering and for increased vision. The present invention is not designed for use when its associated trailer is being moved, but rather is a device when the trailer is stationary for overnight and twilight periods, wherein the lights illuminate the surrounding area or campground.

U.S. Pat. No. 7,425,088 to Weitzel discloses a vehicle running light system that activates a vehicle's running lights upon activation of one or more existing vehicle lights, such as parking lights, brake lights and turn signals. A vehicle running light system provides increased awareness of one's vehicle for other drivers, increased awareness of nearby vehicle surroundings for the driver of the vehicle, and for increased personalization and aesthetic value for the driver's vehicle. The Weitzel device provides a controller within the vehicle that receives multiple input signals corresponding to a plurality of operating modes for selectively initiating activation of at least one of the running lights in accordance with one of the vehicle's existing lights. The existing lights include parking lights, turn signal lights, courtesy lights, brake lights, headlights, hazard lights and combinations thereof. The present invention, by contrast, provides a twilight lighting system that utilizes existing exterior lighting from a trailer to illuminate a campground or exterior setting adjacent to a parked trailer.

U.S. Pat. No. 5,775,712 to Link discloses a method and apparatus that converts trailer marker lights to flashing hazard lights upon separation of the towing vehicle power from the trailer. A battery, a flasher and a solenoid switch is provided for operating the trailer marker lights in one of two modes. The first mode involves electrical connectivity with the towing vehicle while the second mode receives power from the trailer battery. The solenoid switches the power supply for the flasher and the marker lights. In this way, a tractor trailer disconnected from its towed vehicle, such as during an accident, roadside emergency or parking situation, the marker lights are energized independently from the towing vehicle to indicate an emergency for other road-going vehicles to observe. While providing a safety device, the Link device fails to disclose the novel aspects of the present invention, which are limited to towed trailers having their own battery power for operating exterior lights only in dim light situations and while disconnected from their towed vehicle.

Finally, U.S. Pat. No. 7,355,347 to Bell discloses a vehicle dual mode lighting system that allows control over the primary and auxiliary lights of the vehicle, even when the car is not running. This allows the vehicle to operatively black-out vehicle lighting for military and civilian purposes. A toggle switch allows control over the vehicle lights while the car is operational or parked, preventing inadvertent light operation on the vehicle when the switch is activated. The Bell device offers a means to control a vehicle's external and internal lighting for military covert use. The present invention is related to family trailers in use in campgrounds, where night lighting is provided for vision external to the trailer and to ward away animals from the trailer.

The present invention provides a simple module that plugs into a trailer power connector to route the trailer battery power to the exterior lights and other running lights using a light sensitive switch. The device provides a module that is engagable with the connector when the trailer is electrically disconnected from the lead vehicle, such as when parked or when settled in for the night at a campground. It is submitted that the present invention is substantially divergent in design elements from the prior art, and consequently it is clear that there is a need in the art for an improvement to existing parked trailer twilight lighting systems devices. In this regard the instant invention substantially fulfills these needs.

### SUMMARY OF THE INVENTION

In view of the foregoing disadvantages inherent in the known types of trailer lighting systems now present in the prior art, the present invention provides a new towed vehicle, trailer and recreational vehicle lighting system that be utilized for providing convenience for the user when illuminating an area surrounding the parked vehicle in twilight or low light conditions.

It is therefore an object of the present invention to provide a new and improved trailer lighting system that has all of the advantages of the prior art and none of the disadvantages.

It is another object of the present invention to provide a trailer lighting system that is designed for use with a towed vehicle having onboard battery power and when that towed vehicle is parked for a duration in low light conditions.

Another object of the present invention is to provide a trailer lighting system that utilizes an existing power connection from the towed vehicle and routes power from the onboard battery to the exterior running lights using a relay and a light sensitive switch.

Yet another object of the present invention is to provide a trailer lighting system that provides a readily attachable module, connectable to a common trailer power connection that operates the external running lights when the ambient light drops below a given threshold, for instance during twilight hours.

A final object of the present invention is to provide a trailer lighting system that offers an inexpensive, convenient and readily deployable plug connector that increases lighting around a towed trailer or recreational vehicle for nighttime vision purposes and added security while parked for long durations.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded perspective view of the present invention being connected to a common trailer electrical connector.

FIG. 2 shows an internal schematic view of the present invention when connected to a common trailer electrical connector.

FIG. 3 shows a flow chart highlighting the overall operation of the present invention in use.

FIG. 4 shows a view of the device in use with a towed trailer in a low light environment.

### DETAILED DESCRIPTION OF THE INVENTION

Reference is made herein to the attached drawings. Like reference numerals are used throughout the drawings to depict like or similar elements of the trailer lighting system. For the purposes of presenting a brief and clear description of the present invention, the preferred embodiment will be discussed as used for operating the exterior running lights of a towed vehicle when parked during low light conditions and when electrically disconnected from a towing vehicle. The figures are intended for representative purposes only and should not be considered to be limiting in any respect.

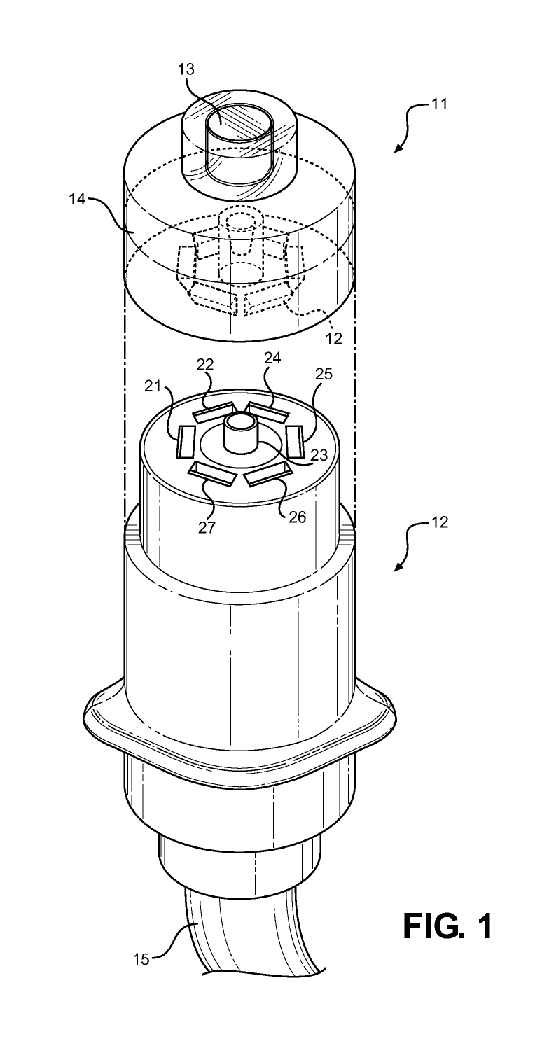

Referring now to FIG. 1, there is shown an exploded view of the present invention being coupled to a recreational vehicle or trailer electrical connector 12, which is otherwise adapted to be connected to the lead vehicle to supply a towed vehicle with a continuous source of electricity from the lead vehicle battery and alternator. The present invention is adapted to provide electrical connectors that are aligned to the specific style of the towed vehicle electrical plug 12, and reroute the towed vehicle battery power to the towed vehicle external lights for increased visibility at night and in low light environments. It is required that the lead vehicle be electrically disconnected from the towed vehicle to effectuate the connection and use of the present invention, whereby power is not drawn from the lead vehicle, but rather the towed vehicle onboard power is utilized as a means to power external lights when the lighting in the exterior environment drops below a defined threshold.

The device itself comprises an electrical module 11 having a body structure 14 adapted to house an internal circuit, an upper portion 13 for supporting a light sensor element and a lower portion comprising electrical connectors aligned with that of the specific towed vehicle electrical plug 12 that is otherwise adapted to draw power from a lead vehicle while being towed. The connectors of the plug 12 are provided in a common arrangement that are well known to those skilled in the art of trailers, recreational vehicles and towed campers. These generally include a plurality of electrical connectors that route current from the lead vehicle to the towed vehicle batter, directly to operating lights such as turn signals, brake lights and running lights, and further for providing an electrical ground. The specific arrangement of the plug 12 and its connectors is not of primary relevance with regard to the intent of the present invention, which portends to provide a means to reroute onboard battery power directly to those exterior operating lights when the vehicle is parked and disconnected from a lead vehicle. Rather than supplying power and controlling these lights from the lead vehicle, the onboard power operates the lights using a light sensitive switch in the module upper portion 13. The module 11 and plug 12, once connected, can be placed in a position to actively monitor the visibility and lighting of the surrounding area, and in turn operate the vehicle exterior lights when the sky darkens, the environment darkens or the time is near dusk or twilight.

In a particular and preferred embodiment, and one that has been shown to operate in the field, is the application of the present module 11 in conjunction with a seven-way RV style electrical plug having blade style connectors. In this embodiment, there are provided seven “blades,” or electrical connectors, which are each present to fulfill a function. Referring to FIG. 1, blades 21-27 are as follows (in respective order): right turn signal control 21, towed vehicle battery power 22, reverse lights 23, running lights 24, left turn signal control 25, electrical ground 26 and brake light control 27. Electrical signals are adapted to be sent from a connected lead vehicle through this electrical plug according to the foregoing connectors. Specific vehicle functions are routed through their respective connector, such as brake light and turn signal control and auxiliary power from the lead vehicle to the towed vehicle battery. When disconnected from the lead vehicle, these electrical connections are capitalized on to route onboard battery power to exterior lighting on the towed vehicle without external power, control or added wiring that is not already present.

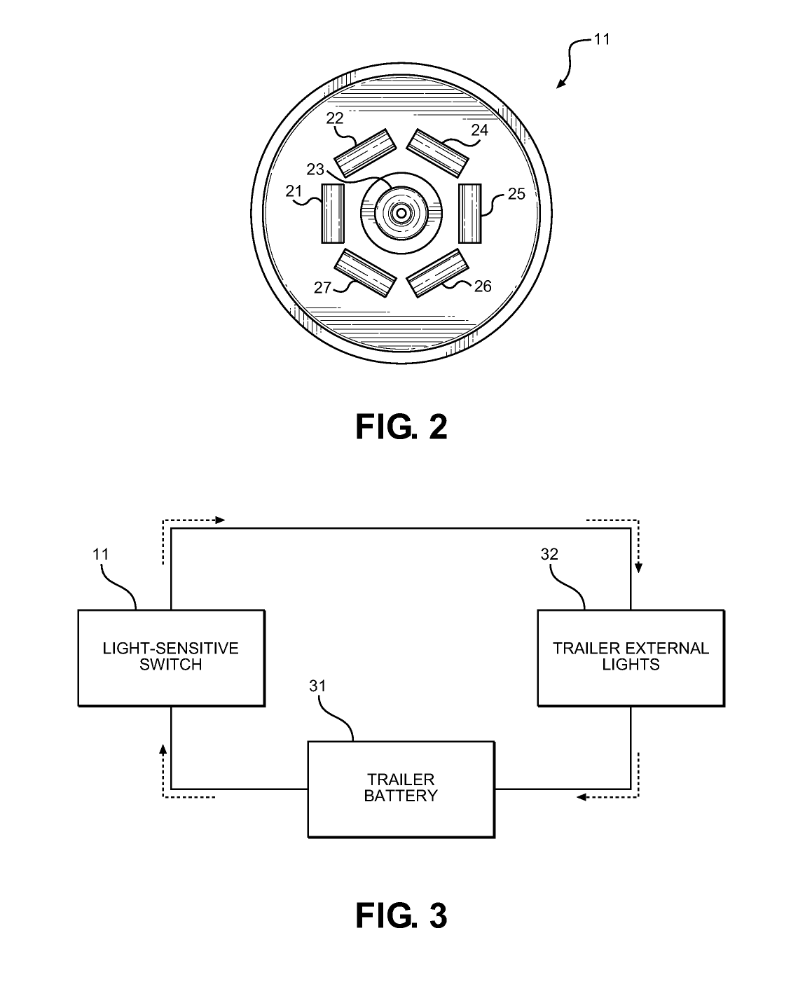

To accomplish this, we refer to FIG. 2, which shows an embodiment of the present module 11 and a schematic view of its internal electrical layout with respect to the seven-way vehicle plug. The device is a circuit that wires together the towed vehicle electrical power (onboard battery) through a light sensitive switch in the upper portion 13 of the module, which modulates a relay or directly allows current to flow from the battery connector 22 to the vehicle running lights 24 and then to the electrical ground 26. When the ambient environment is sufficient lit, the switch is open and does not draw current from the battery connector 22. When the ambient light lowers below a defined threshold as designed in the light sensor, the switch is closed or a relay is operated to allow current to flow from the battery connector 22 to the vehicle lighting connector 24 to ground 26. Other vehicle lights may be included in the wiring of the module, including the brake lights, turn signal lights and/or the reverse lights. These are generally high intensity lights as compared to running lights, which may or may not be desired for the user. It is contemplated that the module may be provided in several forms to accommodate different user needs, include those that from further switches in parallel to the running lights, wherein these switches control current flowing to the turn signals, brake lights and or the reverse light. Additional wiring and electrical hardware is required for these additional features, but their incorporate is herein contemplated for further embodiments of the module. It is further contemplated and plainly realized that variations in the towed vehicle plug connector layout and style may be designed or utilized by specific trailers, which require minor adjustments to the module 11 design and electrical layout. It is desired to provide a module that may be utilized by a number of different plug layouts, including those having greater or fewer number of connectors. It is further not desired to limit the present invention to a particular style plug, but rather to disclose a novel concept that reroutes onboard power using a light sensitive switch for illumination of an area proxy to a parked trailer or recreational vehicle in twilight hours.

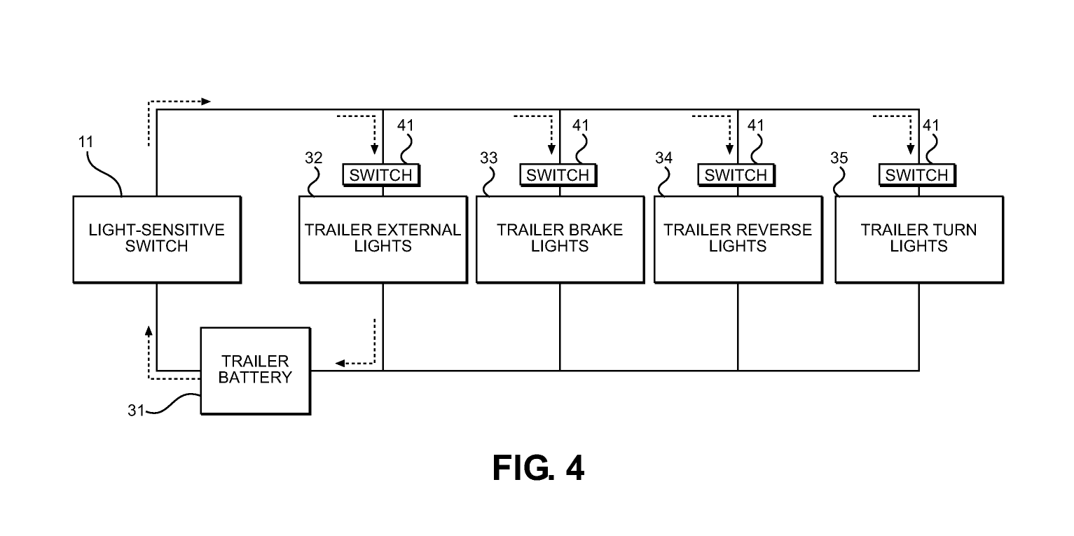

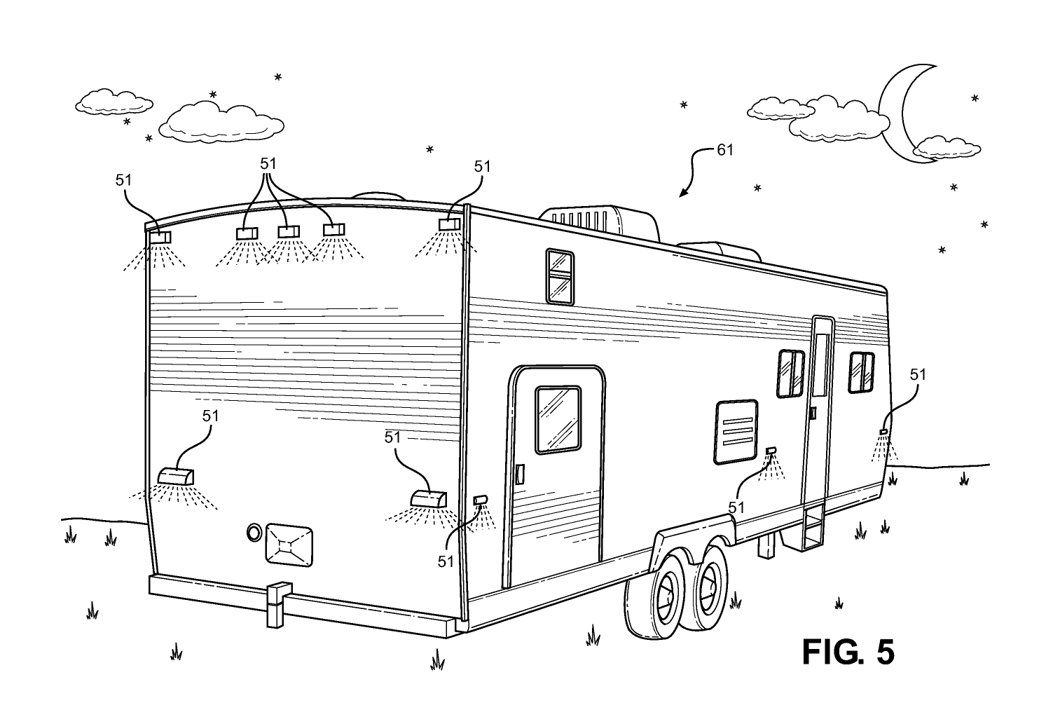

Referring now to FIG. 3, there is shown a flow diagram or schematic of the operation of the preferred embodiment of the present invention, wherein the external running lights are operable in conjunction with the present module. When connected, the module connects the trailer or towed vehicle battery 31 to a light sensor 11, which is a switch or includes an accompanying relay. When the light sensor is activated in low light, the switch closes or the relay is closed to allow current to flow to the towed vehicle external running lights 32. The light sensor is an electronic device that comprises a photocell, which changes resistance based on light projected onto a photoconductive surface. The light sensor operates a switch or relay that allows current to flow therethrough and into the towed vehicle lights connected downstream. This embodiment has been shown to be effective in use, and provides a means to illuminate a campground around a towed recreation vehicle in low light and further to prevent battery drainage through continuous use during daylight hours. Further embodiments incorporate user switches and parallel branches in the circuit, wherein the trailer brake lights, reverse lights and turn signals are placed in parallel branches with respect to the running lights 32. As shown in FIG. 4, user switches 41 are provided in each parallel branch, including the branch to the running lights 32, allow the user to control which lights are operational when the module is connected. The switches can be controlled from the exterior of the module by the user when attached to the towed vehicle electrical plug, and allow different lights to be utilized. Each individual switch 41 allows current to flow to different exterior lights, including the trailer running lights 32, brake lights 33, reverse lights 34 and turn signals 35, which would undergo continuous operation rather than pulsing. Overall, this embodiment provides flexibility with regard to the amount of current draw and exterior illumination in the immediate area of the parked trailer.

Referring finally to FIG. 5, there is shown an overall concept view of the present invention, wherein a perspective view from the exterior of a towed vehicle 61 is shown with the present invention in operation in a low light environment. In this view, the module is connected to the trailer power plug, and the running lights 51 of the trailer are in operation via the onboard battery power and the closed light sensor switch. It is submitted that during evening and dusk hours, security at an RV or trailer campground may become an issue. A dark campsite subjects individuals and the individual's property to theft and vandalism. In these times, camp goers may be unable to get around the campsite without a flashlight, which may be inconvenient if there are not enough lights or if the individual is required to perform a given task or utilize nearby facilities. The present invention allows users to feel less vulnerable in dark campsite environments by keeping their towed vehicle lights energized during the night and during low light times of the day. Onboard battery power is utilized, so the threat of draining the lead vehicle battery is eliminated, and further the area is given a soft lighting to allow navigation and inspection of the campground area around the trailer at night. The device is adapted to install on an existing trailer control cable when the cable is disconnected from the lead vehicle, wherein a light-sensitive electrical sensor reroutes onboard power to provide twilight illumination without the need for expensive or involved installation procedures of auxiliary lighting systems, and further does not require the lead vehicle to operate or provide power during operation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A towed vehicle exterior lighting control device, comprising:
an electrical module connectable to a towed vehicle power plug when disconnected from a lead vehicle, the module having an internal electric circuit, a light sensor, and at least one switch;
the module further comprises electrical connectors adapted to route said towed vehicle battery power through said electric circuit, wherein least one exterior light is energized on said towed vehicle when said light sensor measures a low light environment.

2) The device of claim 1, wherein said light sensor is a photocell that measures light and operates said switch.

3) The device of claim 1, wherein said towed vehicle exterior light further comprises running lights on said towed vehicle.

4) The device of claim 1, wherein said module further comprises a body structure having an upper portion and a lower portion, said upper portion support said light sensor, sand lower portion providing said towed power plug connectors and said electoral circuit positioned therebetween.

5) The device of claim 1, wherein said electric circuit further comprises:
a photocell that measures light and operates said switch to said at least one towed vehicle exterior lights;
a user switch to control current to said at least one exterior lights.

6) The device of claim 1, wherein said electric circuit further comprises:
a photocell that measures light and operates said switch to said at least one towed vehicle exterior lights;
said towed vehicle exterior lights being separated by type in parallel circuit branches;
each parallel exterior circuit branch having a user switch to control current to each respective exterior light.

7) The device of claim 1, wherein said switch is a relay.

8) The device of claim 1, wherein said towed vehicle power plug further comprises a seven-way blade power plug and said electrical connectors provide electrical connectivity to said blades.
